(19) United States
(12) Patent Application Publication
(10) Pub. No.: US 2026/0100320 A1
(43) Pub. Date: Apr. 9, 2026

(54) BELLOWS PROTECTOR FOR A VACUUM INTERRUPTER

(71) Applicants: Siemens Aktiengesellschaft, München (DE); Maschinenfabrik Reinhausen GmbH, Regensburg (DE)

(72) Inventors: Andreas Lawall, Berlin (DE); Frank Graskowski, Wandlitz (DE); Lydia Baron, Dallgow-Döberitz (DE); Silke Wrede, Zeitlarn (DE)

(21) Appl. No.: 19/114,044

(22) PCT Filed: Sep. 7, 2023
(86) PCT No.: PCT/EP2023/074545

§ 371 Date: Mar. 21, 2025

(30) Foreign Application Priority Data
Sep. 21, 2022 (DE) 10 2022 209 942.7

(51) Int. Cl. H01H 33/662

(52) U.S. Cl. CPC H01H 33/66238; H01H 2033/66246

(57) ABSTRACT

A bellows protector for a vacuum interrupter with an external bellows for low, medium or high voltages has a first region, which is configured tapered and to receive a moving contact rod such that the moving contact rod is guided out of the bellows protector from an inner side of the bellows protector onto a second side outside the bellows protector. The tapered first region of the bellows protector is configured to lie against the moving contact rod such that the moving contact rod is guided through the bellows protector. A second region adjoins the first region, the second region is enlarged relative to the first region such that the bellows to be protected is received in the second region. A holding region is configured to fasten the bellows protector on or to the vacuum interrupter such that the bellows protector forms a guide for the moving contact rod.

The invention relates to a bellows-protector for a vacuum interrupter, to a vacuum interrupter with such a bellows-protector, to a switchgear with a vacuum interrupter with such a bellows-protector, to a stepping switch with a vacuum interrupter with such a bellows-protector, and to a production method for a vacuum interrupter with such a bellows-protector.

Vacuum interrupters with an external bellows are known from the prior art. In the case of such vacuum interrupters with an external bellows, there is a risk that the bellows and the vacuum interrupter will be damaged in the course of transportation, handling and assembly, as well as in the course of switching actions in the installed state, for instance in a switchgear or in a stepping switch. In the installed state, damage to the bellows occurs, for instance, as a result of oblique positioning or axial offset of the moving-contact rod with respect to the axis the vacuum interrupter.

The object of the invention is therefore to eliminate the disadvantages from the prior art.

The object is achieved by virtue of the independent claim 1 and the claims dependent thereon.

One aspect relates to a bellows-protector for a vacuum interrupter with external bellows for low, medium or high voltages, wherein

the bellows-protector exhibits at least:
a first region which has been configured in tapered manner and has further been configured to receive a moving-contact rod in such a manner that the moving-contact rod is capable of being guided through from an inner side of the bellows-protector, out of the bellows-protector, onto a second side outside of the bellows-protector, the tapered first region of the bellows-protector having been configured to bear against the moving-contact rod in such a manner that the moving-contact rod is guided by the bellows-protector,
a second region which adjoins the first region, the second region having been enlarged with respect to the first region in such a manner that the bellows to be protected is receivable in the second region, and
a retaining region, the retaining region having been configured to fasten the bellows-protector on or to the vacuum interrupter in such a manner that the bellows-protector constitutes a guide for the moving-contact rod.

The term “guide” in the sense of this disclosure is to be understood to mean a guiding of the moving contact in a form that prevents the moving-contact rod from exceeding a predetermined angle with respect to the longitudinal axis of the vacuum interrupter, and in this way prevents damage to the bellows as a result of a tilting of the moving-contact rod. This is achieved, in particular, by the tapered region of the first region resting on at least one portion which, in the course of use according to the invention, bears against the moving-contact rod and extends largely parallel to the longitudinal axis of the vacuum interrupter. £ By virtue of the bellows, the moving contact is accordingly arranged so as to be movable in the direction of the longitudinal axis, and is guided by the guide in the course of a movement along the longitudinal axis.

The term “receive” or “receivable” means here, in particular, that the bellows of the moving contact is arranged in an inner region of the bellows-protector-that is to say, on the inner side.

The expression “fasten the bellows-protector to the vacuum interrupter” means here that the bellows-protector is not arranged so as to be movable with the moving contact with respect to the immovable parts of the vacuum interrupter, but rather that the moving contact moves relative to the bellows-protector. A possible rotation of the bellows-protector about the vacuum interrupter is optionally preventable with an additional detent means, in which case the additional detent means interacts with an additional detent-means counterpart on the vacuum interrupter.

The bellows-protector optionally has in its interior a cylindrical geometry which has been adapted to the outer geometry of a vacuum interrupter.

Further optionally, the outer geometry of the bellows-protector also has a cylindrical geometry.

It is preferred that the bellows-protector exhibits in the first region a guide region which takes the form of a slide bearing for the moving contact.

It is particularly preferred that the guide region has been configured in such a way that merely the moving-contact rod can be guided through the guide region, but not a fixed contact of the vacuum interrupter. This is achieved, in particular, by means of a different shaping of the moving contact and of the fixed contact.

It is also preferred that the first region exhibits further rows of slots, and/or the second region and/or third region exhibit(s) rows of slots, which permit a circulation of gas between the inner side of the bellows-protector and the second side outside of the bellows-protector. Rows of slots in the second and third regions also permit, in addition to a circulation of gas, a selective flexibilization of the second and third regions, which facilitates assembly on a vacuum interrupter and nevertheless provides for a sufficiently firm fit of the bellows-protector on the vacuum interrupter.

Furthermore, it is also preferred that the bellows-protector exhibits, on the inner side of the bellows-protector and/or on the second side of the bellows-protector, ribs or crosspieces perpendicular and/or parallel to the longitudinal axis of the vacuum interrupter. These ribs or crosspieces serve for enhancing the mechanical stability of the bellows-protector and/or for extending electrical leakage paths.

It is also preferred that the bellows-protector has been formed in one piece and the retaining region has been designed to extend from the moving-contact side via a first insulator of a vacuum interrupter and to engage, on the side of the first insulator situated opposite the moving contact, in such a manner with a catch on the first insulator or on components of the interrupter tube adjoining the first insulator that the bellows-protector can be fastened to the vacuum interrupter. Components of the interrupter tube adjoining the first insulator are, in particular, the intermediate element and/or the further insulator and/or the shielding element and/or the fixed-contact flange and/or the fixed-contact rod. In particular, it is preferred that the catch either
engages, on the side of the first insulator situated opposite the moving contact, with a catch on the first insulator, and in this way fastens the bellows protector, or
engages, on the side of the first insulator situated opposite the moving contact, with a catch on the fixed-contact flange, and in this way fastens the bellows-protector.

In other words, the catch engages—on the side of the first insulator situated opposite the moving contact, also designated as being located behind the first insulator—with one of the components of the interrupter tube in such a manner that the bellows-protector has been fastened to the vacuum interrupter.

It is also preferred that the bellows-protector has been formed in multiple pieces—in particular, in two pieces—in which case the bellows-protector exhibits at least a first bellows-protector element and a further bellows-protector element, the first bellows-protector element and the further bellows-protector element being connected to one another or capable of being connected to one another.

It is advantageous if the first bellows-protector element and the further bellows-protector element are capable of being connected to one another by being brought together, that is to say, being capable of being brought together, the first bellows-protector element from the side with the moving contact, and the further bellows-protector element from the side situated opposite the moving contact. Particularly preferably, the further bellows-protector element also exhibits a tapered first region by which a fixed-contact rod is capable of being guided. Alternatively, instead of the fixed-contact rod a further moving-contact rod may also be capable of being guided by the tapered region of the further bellows-protector element; by this means, the bellows protector is also capable of being used for a vacuum interrupter with two moving contacts.

It is also preferred that the connection between the first bellows-protector element and the further bellows-protector element is established by a positive closure or a force closure. In particular, the positive closure is constituted by a detent connection with one or more detents—that is to say, engagement means—and one or more detent depressions. Alternatively, a screw connection or some other connection may have been provided.

Furthermore, it is preferred that the bellows-protector has been formed from an electrically insulating material and has been configured to reduce or to prevent electrical discharges or partial discharges. In particular, discharges or partial discharges between further constituent elements of a switchgear and metallic parts of the vacuum interrupter are reduced or prevented with an appropriate bellows-protector.

The bellows-protector has preferably been formed from a synthetic material and is preferably produced in an injection-molding process.

A further aspect relates to a vacuum interrupter, the vacuum interrupter exhibiting a bellows-protector according to one of the above embodiments.

It is particularly advantageous that the bellows-protector also constitutes, in addition to the protector of the bellows and the guide of the moving-contact rod, at the same time a transportation protector which additionally protects the vacuum interrupter as a whole. The guide of the moving-contact rod serves for avoiding an oblique positioning or an axial offset of the moving-contact rod with respect to the longitudinal axis of the vacuum interrupter.

Furthermore, it is preferred that the fixed contact of the vacuum interrupter exhibits a first detent depression for receiving a further catch. This first detent depression accordingly serves for fastening a further bellows-protector element in the case of a multi-piece—in particular, a two-piece—bellows-protector by means of a catch on the vacuum interrupter. The first detent depression preferably exhibits an inverse structure in relation to the further catch.

It is particularly preferred that the vacuum interrupter is a vacuum interrupter for a low-voltage, medium-voltage or high-voltage switchgear.

It is also particularly preferred that the vacuum interrupter is a vacuum interrupter for a stepping switch—in particular, an on-load stepping switch.

One aspect also relates to a switchgear with a vacuum interrupter or with several vacuum interrupters according to one of the above embodiments with a bellows-protector according to one of the above embodiments.

A further aspect relates to a stepping switch with one or more vacuum interrupters, one or more of the vacuum interrupters exhibiting a bellows-protector according to one of the above embodiments.

Another aspect relates to a method for producing a vacuum interrupter with a bellows-protector, wherein a bellows-protector according to one of the above embodiments is fastened to a vacuum interrupter. In particular, it is preferred that the bellows-protector r is fastened to the vacuum interrupter by being pushed onto the vacuum interrupter, in particular is fastened to the vacuum interrupter by being locked into place.

The expression “fasten the bellows-protector to the vacuum interrupter” means here that the bellows-protector does not move with respect to the immovable parts of the vacuum interrupter, but rather the moving contact moves relative to the bellows-protector and relative to the non-moving parts of the vacuum interrupter. Non-moving parts of the vacuum interrupter are, for example, a first insulator, a further insulator, an intermediate element or a fixed contact.

With regard to the device according to the invention, all the statements made above and below relating to the method according to the invention apply in corresponding manner, and conversely. Also with regard to the advantages of the device according to the invention, reference is made to the described advantages relating to the method according to the invention, and conversely.

The invention will be elucidated in more detail below with reference to an embodiment example. The specific configuration of the embodiment example is not to be understood as being restrictive in any way for the general configuration of the method according to the invention or of the device according to the invention; rather, individual design features of the embodiment example can be freely combined in arbitrary manner with one another and with the features described above.

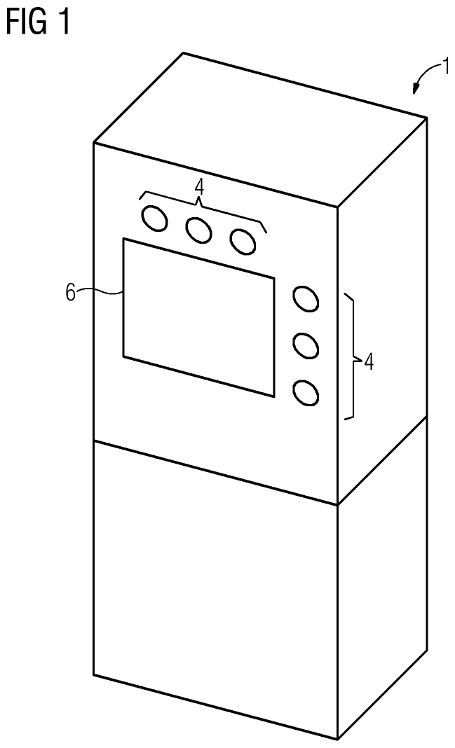

FIG. 1: A SCHEMATIC REPRESENTATION OF A SWITCHGEAR;

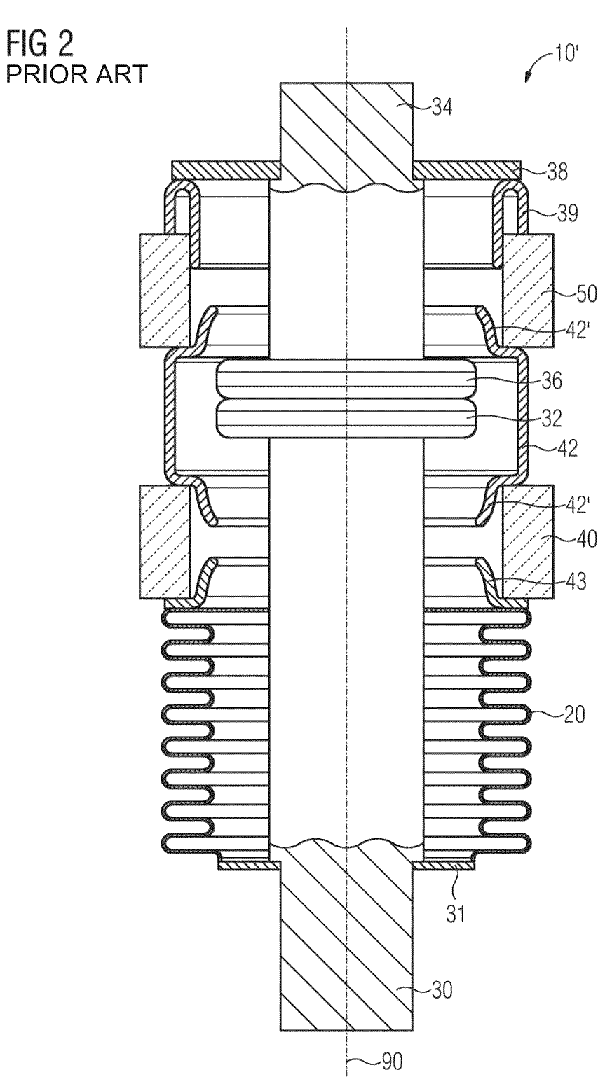

FIG. 2: a schematic representation of a vacuum interrupter from the prior art;

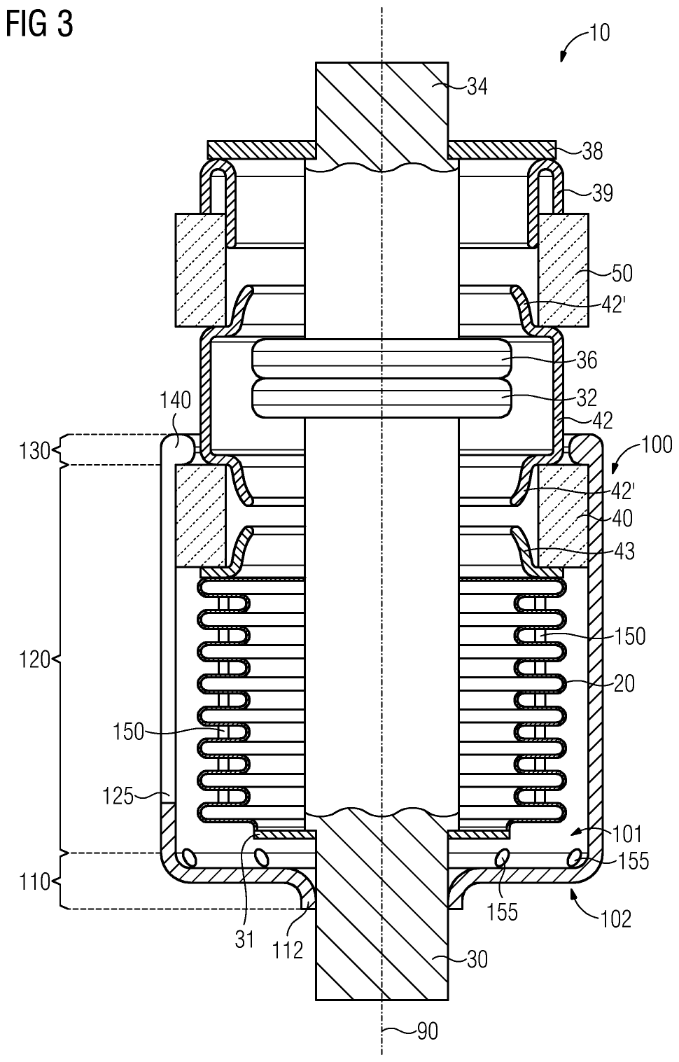

FIG. 3: a schematic representation of a vacuum interrupter with a one-piece bellows-protector;

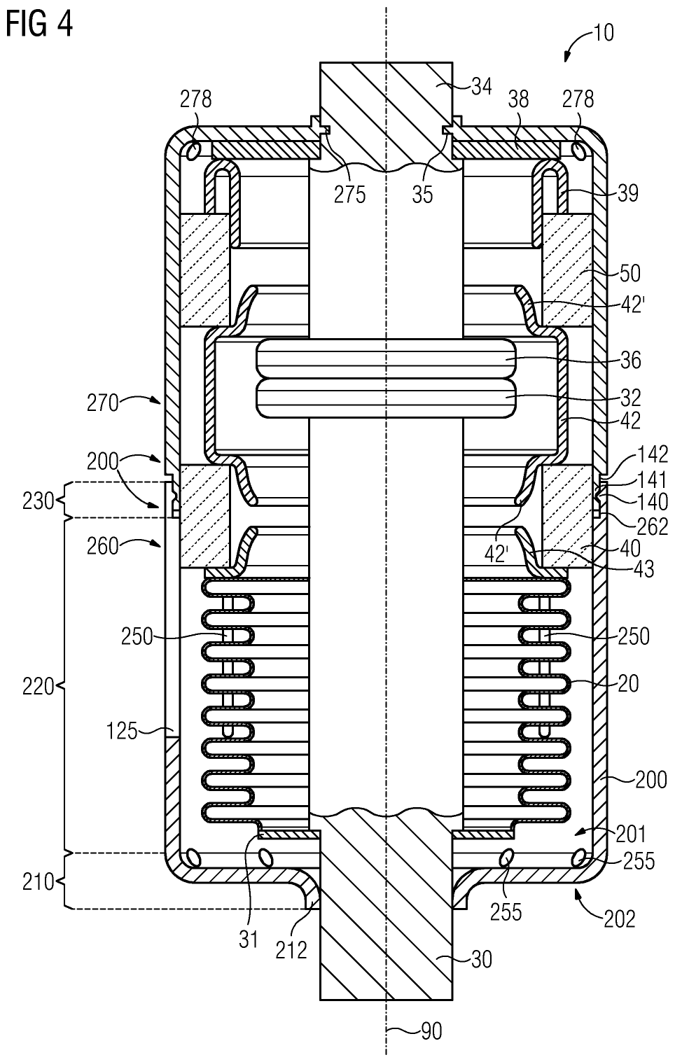

FIG. 4: a schematic representation of a vacuum interrupter with a two-piece bellows-protector.

FIG. 1 shows a schematic representation of a switchgear 1; here, a medium-voltage switchgear is shown by way of example, but a switchgear for low or high voltages is also possible which exhibits a vacuum interrupter for connecting up or disconnecting an electric current and/or an electrical voltage. The switchgear may, in particular, include one or more vacuum interrupters by way of switching element—in particular, vacuum interrupters that take the form of load switches or circuit-breakers. The switchgear exhibits indicating elements 4 which may include indicators such as a pressure indicator, a switching-position indicator or other status indicators. Furthermore, the switchgear exhibits a control panel 6 via which, for instance, switching actions can be undertaken.

FIG. 2 shows a schematic representation of a vacuum interrupter 10′from the prior art. The vacuum interrupter 10′has a cylindrical basic shape with a longitudinal axis 90. A fixed-contact rod 34 extends along or parallel to the longitudinal axis 90 and has been guided by a fixed-contact flange 38 into the interior of the vacuum interrupter 10′. The fixed-contact rod 34 is adjoined by a fixed-contact disk 36. The fixed-contact disk 36 is adjoined by a moving-contact disk 32 on a moving-contact rod 30. The moving-contact rod 30 is connected to the moving-contact disk 32 via a moving-contact flange 31 with an external bellows 20 and with a bellows-shielding element 43 movably arranged on a first insulator 40—in particular, soldered thereto. In the example shown in FIG. 2, the first insulator 40—here, an insulator made of a ceramic material, that is to say a ceramic insulator—is adjoined by an intermediate element 42—here, a metallic intermediate element 42—which in the interior of the vacuum interrupter 10′constitutes here, at the same time, a further shielding element 42′which, at least in a position in which the fixed-contact disk 36 and the moving-contact disk 32 touch one another and the vacuum interrupter 10′is in a closed—that is to say, current-conducting—state, radially encompassed, with a spacing. The further shielding element constituted by the intermediate element 42 is particularly suitable to prevent to minimize a vapor deposition or deposition of material on the first insulator 40 and/or on the further insulator 50 in the case of a switching arc.

The intermediate element 42 is adjoined here by a further insulator 50.

The further insulator 50 is adjoined here by a shielding element 39. The shielding element 39 also serves here as a connection to the fixed-contact flange 38. Alternatively, the shielding element 39 and a further insulator 50 may be dispensed with, and the fixed-contact flange 38 may directly adjoin the intermediate element 42.

FIG. 3 shows a schematic representation of a vacuum interrupter 10 according to the invention with a one-piece bellows-protector 100 according to the invention.

The structure of the vacuum interrupter 10 is analogous to that of the vacuum interrupter 10′from the prior art and from FIG. 2. The vacuum interrupter 10 has a cylindrical basic shape with a longitudinal axis 90. A fixed-contact rod 34 extends along or parallel to the longitudinal axis 90 and has been guided by a fixed-contact flange 38 into the interior of the vacuum interrupter 10. The fixed-contact rod 34 is adjoined by a fixed-contact disk 36. The fixed-contact disk 36 is adjoined by a moving-contact disk 32 on a moving-contact rod 30. The moving-contact rod 30 is connected to the moving-contact disk 32 via a moving-contact flange 31 with an external bellows 20 movably arranged on a first insulator 40—in particular, soldered thereto. A bellows-shielding element 43 is arranged between the bellows 20 and the first insulator 40. In the example shown in FIG. 3, the first insulator 40—here, an insulator made of a ceramic material, that is to say a ceramic insulator—is adjoined by an intermediate element 42—here, a metallic intermediate element 42. In the interior of the vacuum interrupter 10 the intermediate element 42 constitutes here, at the same time, a further shielding element 42′, or one or more further shielding elements 42′has/have been arranged on the intermediate element. The arrangement of the further shielding elements 42′has been configured in such a manner that, at least in a position in which the fixed-contact disk 36 and the moving-contact disk 32 touch one another, and in this way the vacuum interrupter 10 is in a closed—that is to say, current-conducting—state, the fixed-contact disk 36 and the moving-contact disk 32 are radially encompassed with a spacing. The further shielding element constituted by the intermediate element 42 is particularly suitable to prevent or to minimize a vapor deposition or a deposition of material on the first insulator 40 and/or on the further insulator 50 in the case of a switching arc.

The intermediate element 42 is adjoined here by a further insulator 50.

The further insulator 50 is adjoined here by a shielding element 39. The shielding element 39 also serves here as a connection to the fixed-contact flange 38. Alternatively, the shielding element 39 and a further insulator 50 may be dispensed with, and the fixed-contact flange 38 may directly adjoin the intermediate element 42.

Furthermore, FIG. 3 shows the bellows-protector 100 according to the invention. This bellows-protector 100 has been formed here in one piece and has been subdivided into three regions. A part of the vacuum interrupter 10 is located on the inner side 101 of the bellows-protector 100, whereas the moving-contact rod 30 has been guided from the inner side 101 of the bellows-protector 100 through the bellows-protector 100 onto the second side 102 outside of the bellows-protector 100.

The first region 110 of the bellows-protector 100 exhibits a taper, the diameter of the bellows-protector 100 in the first region 110 decreasing from a diameter receiving the bellows 20 to a diameter guiding the moving-contact rod 30. Consequently a guide, a bearing 112 for the moving-contact rod 30, is formed. Optionally, in the first region 110 further rows of slots 155 for the through-flow of gas may have been provided in the bellows-protector 100. Optionally, these further rows of slots 155 in the first region 110 may also serve for making the bellows-protector 100 more flexible for the purpose of guiding the moving-contact rod 30.

In the second region 120 of the bellows-protector 100 the bellows-protector here extends largely parallel to the longitudinal axis 90 of the vacuum interrupter.

The retaining region 130 exhibits here, on the side facing toward the longitudinal axis 90 of the vacuum interrupter 10, catch 140 which, coming from the side with the moving-contact rod 30 and the bellows 20, has been guided via the first insulator 40 and locked into place behind the first insulator 40, and in this way fastens the bellows-protector 100 to and on the vacuum interrupter 10. In order to enable the guiding of the retaining region 130 via the first insulator 40, the bellows-protector 100 exhibits rows of slots 150 which here extend from the beginning 125 of the row of slots 150 as far as an end of the bellows-protector 100 with the catch(es) 140. In particular, a large number of rows of slots 150 are present here—in particular, 4, 5, 6, 7 or more rows of slots 150. In this way, a ring of flexible retaining elements 130, each with a catch 140, is formed which brings about a firm fit on the vacuum interrupter 10 and at the same time brings about straightforward assembly.

FIG. 4 shows a schematic representation of a vacuum interrupter 10 according to the invention with a two-piece bellows-protector 200 according to the invention.

The structure of the vacuum interrupter 10 is largely analogous to that of the vacuum interrupter 10′known from the prior art, shown in FIG. 2, and to that of the vacuum interrupter 10 from FIG. 3. Deviating from the figures previously described, however, the fixed-contact rod 34 exhibits a first detent depression 35 for receiving a further catch 275 and for fastening a further bellows-protector element 270 in the case of a multi-piece—here, two-piece—bellows-protector.

The vacuum interrupter 10 has a cylindrical basic shape with a longitudinal axis 90. A fixed-contact rod 34 extends along or parallel to the longitudinal axis 90 and has been guided by a fixed-contact flange 38 into the interior of the vacuum interrupter 10. The fixed-contact rod 34 is adjoined by a fixed-contact disk 36. The fixed-contact disk 36 is adjoined by a moving-contact disk 32 on a moving-contact rod 30. The moving-contact rod 30 is connected to the moving-contact disk 32 via a moving-contact flange 31 with an external bellows 20 movably arranged on a first insulator 40—in particular, soldered thereto. A bellows-shielding element 43 is arranged between the bellows 20 and the first insulator 40. In the example shown in FIG. 4, the first insulator 40—here, an insulator made of a ceramic material, that is to say a ceramic insulator—is adjoined by an intermediate element 42—here, a metallic intermediate element 42. In the interior of the vacuum interrupter 10 the intermediate element 42 constitutes here, at the same time, a further shielding element 42′, or one or more further shielding elements 42′has/have been arranged on the intermediate element. The arrangement of the further shielding elements 42′has been configured in such a manner that, at least in a position in which the fixed-contact disk 36 and the moving-contact disk 32 touch one another, and in this way the vacuum interrupter 10 is in a closed—that is to say, current-conducting—state, the fixed-contact disk 36 and the moving-contact disk 32 are radially encompassed with a spacing. The further shielding element 42′ constituted by the intermediate element 42 is particularly suitable to prevent or to minimize a vapor deposition or a deposition of material the first insulator 40 and/or on the further insulator 50 in the case of a switching arc.

The intermediate element 42 is adjoined here by a further insulator 50.

The further insulator 50 is adjoined here by a shielding element 39. The shielding element 39 also serves here as a connection to the fixed-contact flange 38. Alternatively, the shielding element 39 and the further insulator 50 may be dispensed with, and the fixed-contact flange 38 may directly adjoin the intermediate element 42.

Furthermore, FIG. 4 shows the two-piece bellows-protector 200 according to the invention as an example of a multi-piece bellows-protector. This bellows-protector 200 has been formed here from the first bellows-protector element 260 and from the further bellows-protector element 270. The first bellows-protector element 260 has been subdivided into three regions. A part of the vacuum interrupter 10 is located on the inner side 201 of the bellows-protector 200, whereas the moving-contact rod 30 and the fixed-contact rod 34 have been guided from the inner side 201 of the bellows-protector 200 through the bellows-protector 200 onto the second side 202 outside of the bellows-protector 200.

The first region 210 of the bellows-protector 200 exhibits a taper, the diameter of the bellows-protector 200 in the first region 210 decreasing from a diameter receiving the bellows 20 to a diameter guiding the moving-contact rod 30. Consequently a guide, a bearing 212 for the moving-contact rod 30, is formed. Optionally, in the first region 210 further rows of slots 255 for the through-flow of gas may have been provided in the bellows-protector 200. Optionally, these further rows of slots 255 in the first region 210 may also serve for making the bellows-protector 200 more flexible for the purpose of guiding the moving-contact rod 30.

In the second region 220 of the bellows-protector 200 the bellows-protector here extends largely parallel to the longitudinal axis 90 of the vacuum interrupter.

The retaining region 230 here exhibits, on the side facing toward the longitudinal axis 90 of the vacuum interrupter 10, a catch 140 which, coming from the side with the moving-contact rod 30 and the bellows 20, has been guided at least partly via the first insulator 40 and locked into place in a second detent depression 141 of the further bellows-protector element, and in this way fastens the first bellows-protector element 260 of the multi-piece bellows-protector 200 to and on the further bellows-protector element 270 and thereby to and on the vacuum interrupter 10. The further bellows-protector element 270 has been fastened to the fixed-contact rod 34 with the further catch 275 in the first detent depression 35, and widens in the direction of the moving-contact flange 31, in order to receive a part of the vacuum interrupter 10. Furthermore, the further bellows-protector element 270 preferably exhibits a further recess 142, so that the second detent depression is arranged in the region of the further recess 142—here, at the end pointing toward the moving-contact flange 31. More preferably, the first bellows-protector element 260 exhibits a first recess 262, the catch 140 being arranged in this first recess 262. A configuration of such a type makes it possible that, for the purpose of fastening to the vacuum interrupter 10, the first bellows-protector element 260 is capable of being interlocked with the further bellows-protector element 270 and is interlocked here. Alternatively, complementary threads are present in the first recess 262 and in the further recess 142, so that the first bellows-protector element 260 can be connected to the further bellows-protector element 270 by means of screw coupling.

In order to enable the guiding of the retaining region 230 via the first insulator 40, and the interlocking of the first bellows-protector element 260 with the further bellows-protector element 270, the first bellows-protector element 260 exhibits rows slots 250 which here extend from the beginning 125 of the row of slots 250 as far as an end of the first bellows-protector element 260 with the catch(es) 140. In particular, a large number of rows of slots 250 are present here—in particular, 4, 5, 6, 7 or more rows of slots 250. In this way, a ring is formed on flexible retaining elements 230, each with a catch 140 which brings about a firm fit on the vacuum interrupter 10 and at the same time brings about straightforward assembly.

### LIST OF REFERENCE SYMBOLS

1 switchgear
4 Indicating Elements
6 control panel
10 vacuum interrupter
10′vacuum interrupter from the prior art
20 bellows, external bellows of the vacuum interrupter 10, 10′
30 moving-contact rod
31 moving-contact flange
32 moving-contact disk
34 fixed-contact rod
35 first detent depression in the fixed-contact rod 34
36 fixed-contact disk
38 fixed-contact flange
39 shielding element
40 first insulator, in particular made of a ceramic material, of the vacuum interrupter 10, 10′
42 intermediate element, in particular metallic intermediate element
42′further shielding element on the intermediate element 42
43 bellows-shielding element between bellows 20 and first insulator 40
50 further insulator, in particular made of a ceramic material, of the vacuum interrupter 10, 10′
90 longitudinal axis of the vacuum interrupter 10, 10′
100 bellows-protector
101 inner side of the bellows-protector 100
102 second side outside of the bellows-protector 100
110 first region of the bellows-protector 100
112 bearing for a moving-contact rod 30
120 second region of the bellows-protector 100
125 beginning of a row of slots 150
130 retaining region of the bellows-protector 100
140 catch on the retaining region 130 or 230
141 second detent depression, in the further bellows-protector element 270
142 further recess, in the further bellows-protector element 270
150 row of slots, in particular for the through-flow of gas in the bellows-protector 100
155 further row of slots, in particular for the through-flow of gas in the bellows-protector 100
200 bellows-protector in a multi-piece design for a vacuum interrupter 10
201 inner side of the bellows-protector 200
202 second side outside of the bellows-protector 200
210 first region of the bellows-protector 200
212 bearing for a moving-contact rod 30
220 second region of the bellows-protector 200
230 retaining region of the bellows-protector 200
240 catch on the retaining region 230
250 row of slots for the through-flow of gas in the first bellows-protector element 260
255 further row of slots for the through-flow of gas in the first bellows-protector element 260
260 first bellows-protector element of the multi-piece bellows-protector 200
262 first recess, in the first bellows-protector element 260
270 further bellows-protector element, of the multi-piece bellows-protector 200
275 further catch for locking into place in the first detent depression 35 of the fixed-contact rod 34
278 second further row of slots, in particular for the through-flow of gas in the further bellows-protector element 270

1-11. (canceled)

12. A bellows-protector for a vacuum interrupter with an external bellows for low, medium or high voltages, the bellows-protector comprising:
a tapered first region configured in a tapered manner and further configured to receive a moving-contact rod of the vacuum interrupter such that the moving-contact rod is capable of being guided through from an inner side of the bellows-protector, out of the bellows-protector, onto a second side outside of the bellows-protector, said tapered first region of the bellows-protector configured to bear against the moving-contact rod such that the moving-contact rod is guided by the bellows-protector;
a second region adjoining said first region, said second region being enlarged with respect to said first tapered region such that the external bellows to be protected is receivable in said second region; and
a retaining region configured to fasten the bellows-protector on or to the vacuum interrupter such that the bellows-protector constitutes a guide for the moving-contact rod.

13. The bellows-protector according to claim 12, wherein said tapered first region has a guide region taking a form of a slide bearing for the moving contact.

14. The bellows-protector according to claim 12, wherein:
said tapered first region has rows of slots formed therein; and/or
said second region and/or said third region has further rows of slots formed therein, said slots and further slots permit a circulation of gas between said inner side of the bellows-protector and said second side outside of the bellows-protector.

15. The bellows-protector according to claim 11, further comprising ribs disposed perpendicular and/or parallel to a longitudinal axis of the vacuum interrupter on said inner side of the bellows-protector and/or on said second side of the bellows-protector.

16. The bellows-protector according to claim 11, wherein:
the bellows-protector is formed in one piece; and
said retaining region is configured to extend from a moving-contact side via a first insulator of the vacuum interrupter and to engage, on a side of the first insulator situated opposite a moving contact, in such a manner with a catch on the first insulator or on components of an interrupter tube adjoining the first insulator that the bellows-protector is fastened to the vacuum interrupter.

17. The bellows-protector according to claim 12, wherein the bellows-protector is formed from multiple pieces, said multiple pieces include at least a first bellows-protector element and a second bellows-protector element, said first bellows-protector element and said second bellows-protector element being connected to one another or capable of being connected to one another.

18. The bellows-protector according to claim 11, wherein the bellows-protector is formed from an electrically insulating material and is configured to reduce or to prevent electrical discharges or partial discharges.

19. A vacuum interrupter, comprising:
said bellows-protector according to claim 12.

20. A switchgear, comprising:
said vacuum interrupter according to claim 19.

21. A stepping switch, comprising:
at least one said vacuum interrupter according to claim 19.

22. A method for producing a vacuum interrupter with a bellows-protector, which comprises the step of:
fastening the bellows-protector according to claim 12 to a vacuum interrupter.
